(19) United States
(12) Patent Application Publication
(10) Pub. No.: US 2008/0280712 A1
(43) Pub. Date: Nov. 13, 2008

(54) Chain tensioner

(76) Inventors: Yoshiaki Ryouno, Iwata (JP); Seiji Sato, Iwata (JP); Satoshi Kitano, Iwata (JP); Kouichi Onimaru, Iwata (JP); Goro Nakao, Iwata (JP)

Correspondence Address: WENDEROTH, LIND & PONACK, L.L.P., 2033 K STREET N. W., SUITE 800, WASHINGTON, DC, 20006-1021, US

(21) Appl. No.: 12/149,437

(22) Filed: May 1, 2008

(30) Foreign Application Priority Data
May 7, 2007 (JP) 2007-122292
Jun. 28, 2007 (JP) 2007-170416

(51) Int. Cl. F16H 7/08

(52) U.S. Cl. 474/110

(57) ABSTRACT

A chain tensioner includes a housing defining a cylinder chamber. A plunger is mounted in the cylinder chamber so as to be slidable along an inner surface of the cylinder chamber. A return spring is mounted in the cylinder chamber to bias the plunger outwardly. The housing is formed with an oil supply passage communicating with a pressure chamber defined in the housing behind the plunger. A check valve is disposed at an oil exit of the oil supply passage and configured to close the oil supply passage when the pressure in the pressure chamber is higher than the pressure in the oil supply passage. The housing is formed with a threaded hole extending from an upper portion of an outer periphery of the housing to the pressure chamber. A screw has its external thread in threaded engagement with the internal thread of the threaded hole, whereby a gap, as an air bleed passage, is defined between the internal and external threads. The internal thread of the threaded hole has an internal diameter larger than an internal diameter of an internal thread under JIS.

### BACKGROUND OF THE INVENTION

The present invention relates to a chain tensioner for keeping constant the tension of a timing chain or a timing belt for driving camshafts.

Typically, a chain transmission device for transmitting the rotation of a crankshaft to camshafts through a timing chain or a timing belt (hereinafter simply referred to as the “chain”) includes a chain tensioner for applying an adjusting force to the slack side of the chain, thereby keeping constant the tension of the chain.

Such a chain tensioner is disclosed in JP Patent 3585655. This chain tensioner includes a housing defining a cylinder chamber, a plunger mounted in the cylinder chamber, and a return spring also mounted in the cylinder chamber and biasing the plunger outwardly of the cylinder chamber. The housing is formed with an oil supply passage communicating with a pressure chamber defined in the housing behind the plunger. The pushing force applied to the plunger is damped by oil supplied into the pressure chamber through the oil supply passage.

In the case of a chain tensioner of the type in which the tension of the chain is adjusted by the force of the return spring and the oil pressure, such as a chain tensioner of the oil supply type as described above, if the plunger is rapidly pushed out, outer air may enter the pressure chamber due to a sudden drop in pressure in the pressure chamber.

Also, air contained in the oil to be supplied into the pressure chamber may be fed into the pressure chamber together with the oil.

If air enters the pressure chamber, when the tension of the chain increases and the plunger is pushed in, because the plunger compresses air, the hydraulic damper effect decreases, so that it is impossible to effectively absorb vibration of the chain.

In order to avoid this problem, the abovementioned Japanese patent proposes to form a threaded hole extending from an upper portion of the outer periphery of the housing to the pressure chamber, and insert a screw in the threaded hole, thereby defining a helical gap between the threadedly engaged portions of the screw and the threaded hole. With this arrangement, when the plunger is pushed in and the pressure in the pressure chamber rises, air accumulated in the pressure chamber can be discharged through the helical gap as an air bleed passage.

In this arrangement, the internal thread formed on the inner periphery of the threaded hole has an internal diameter and a pitch diameter that are both determined under JIS (Japanese Industrial Standards), and the screw is formed under JIS too. Thus, the helical gap defined between the threadedly engaged portions of such internal and external threads as the air bleed passage is extremely small.

Therefore, it is impossible to smoothly discharge air in the pressure chamber through the helical gap between the internal and external threads when the plunger is pushed in and the pressure in the pressure chamber rises. Thus, it takes a long time until the chain tensioner functions as a hydraulic damper.

An object of the present invention is to provide a chain tensioner which can smoothly discharge air accumulated in the pressure chamber when the pressure in the pressure chamber rises.

### SUMMARY OF THE INVENTION

In order to achieve this object, the present invention provides a chain tensioner comprising a housing defining a cylinder chamber, a plunger mounted in the cylinder chamber so as to be slidable along an inner surface of the cylinder chamber, a return spring mounted in the cylinder chamber and biasing the plunger outwardly of the cylinder chamber, the housing being formed with an oil supply passage communicating with a pressure chamber defined in the housing behind the plunger, a check valve disposed at an oil exit of the oil supply passage and configured to close the oil supply passage when the pressure in the pressure chamber is higher than the pressure in the oil supply passage, the housing being formed with a threaded hole extending from an upper portion of an outer periphery of the housing to the pressure chamber and having an internal thread formed on an inner periphery thereof, and a screw having an external thread formed on an outer periphery thereof and kept in threaded engagement with the internal thread of the threaded hole, whereby a gap is defined between threadedly engaged portions of the internal and external threads, the gap serving as an air bleed passage, wherein the internal thread of the threaded hole has an internal diameter larger than an internal diameter of an internal thread under JIS, or the external thread of the screw has an external diameter smaller than an external diameter of an external thread under JIS.

With this arrangement, it is possible form a relatively large gap (air bleed passage) between the threadedly engaged portions of the internal thread on the inner periphery of the threaded hole and the external thread on the outer periphery of the screw. This in turn makes it possible to smoothly expel air accumulated in the pressure chamber through this air bleed passage when the plunger retracts and the pressure in the pressure chamber rises.

From another aspect of the invention, there is provided a chain tensioner comprising a housing defining a cylinder chamber, a plunger mounted in the cylinder chamber so as to be slidable along an inner surface of the cylinder chamber, a return spring mounted in the cylinder chamber and biasing the plunger outwardly of the cylinder chamber, the housing being formed with an oil supply passage communicating with a pressure chamber defined in the housing behind the plunger, a check valve disposed at an oil exit of the oil supply passage and configured to close the oil supply passage when the pressure in the pressure chamber is higher than the pressure in the oil supply passage, the housing being formed with a threaded hole extending from an upper portion of an outer periphery of the housing to the pressure chamber and having an internal thread formed on an inner periphery thereof, and a screw having an external thread formed on an outer periphery thereof and kept in threaded engagement with the internal thread of the threaded hole, whereby a gap is defined between threadedly engaged portions of the internal and external threads, the gap serving as an air bleed passage, wherein the internal thread of the threaded hole has a pitch diameter larger than a pitch diameter of an internal thread under JIS, or the external thread of the screw has a pitch diameter smaller than a pitch diameter of an external thread under JIS.

With this arrangement, a relatively large gap (air bleed passage) is formed between the bottom of the internal thread and the top of the external thread or between the top of the internal thread and the bottom of the external thread. Further, a gap (air bleed passage) is also formed between the opposed flanks of the internal and external threads. Thus, it is possible to expel air accumulated in the pressure chamber through this air bleed passage when the plunger retracts and the pressure in the pressure chamber rises. The hydraulic damper can thus quickly return to its fully functional state.

In the specific arrangement of such a chain tensioner, the plunger is formed with a rod inserting hole having a rear opening facing the check valve and a front closed end, and includes an internal thread having a serration-shaped section and formed on an inner periphery of the rod inserting hole, and the chain tensioner further comprises a screw rod including an external thread having a serration-shaped section and formed on an outer periphery thereof, the screw rod being inserted in the rod inserting hole with the external thread thereof in threaded engagement with the internal thread of the plunger, the screw rod having a spring receiving bore extending along an axis of the screw rod and having a front open end and a rear end surface, and an oil passage extending along the axis of the screw rod from the rear end surface of the spring receiving bore to a rear end surface of the screw rod, the check valve including a valve seat formed with a cylindrical portion having an end surface, and a rod spring mounted between the front closed end of the rod inserting hole and the rear end surface of the spring receiving bore and biasing the screw rod toward the end surface of the cylindrical portion of the valve seat, and the plunger outwardly. With this arrangement, while the engine is at a stop, if a pushing force is applied to the plunger from the chain through the chain guide according to the positions of the cams when they stop, the pushing force is supported by the pressure flanks of the internal and external threads at their threadedly engaged portions. This prevents the plunger from being pushed deep into the cylinder chamber.

Thus, when the engine is restarted, the chain does not markedly slacken. Also, because the plunger does not markedly protrude outwardly, outer air is less likely to enter the cylinder chamber, so that the hydraulic damper effect does not deteriorate.

In the case of a chain tensioner of the type in which oil is fed into the housing through an oil supply passage formed in the housing, when the engine is stopped, oil in the housing and the oil supply passage returns to the oil pump. When the engine is restarted, air is fed together with oil into the cylinder chamber. If the air remains in the cylinder chamber, it deteriorates the hydraulic damper function. Also, if it takes a long time to expel air, when the tension of the chain changes before the cylinder chamber is filled with oil, the chain tends to flap violently, thus producing noise.

Thus, with this type of chain tensioner, it is necessary to expel air in the cylinder as quickly as possible. Thus, in either of the above-described two arrangements of the present invention, the tensioner is preferably mounted with the housing inclined such that the plunger protrudes obliquely downwardly from the housing with the air bleed passage located at a higher level.

In the case of a chain tensioner in which a serration-shaped external thread of a screw rod is brought into engagement with a serration-shaped internal thread of a plunger, if the housing is inclined such that the plunger protrudes obliquely downwardly from the housing, air flows through the oil passage and then the rod inserting hole to the closed end of the rod inserting hole. Then, air turns 180°, and flows through the gap between the threadedly engaged portions of the internal and external threads into the cylinder chamber. Thus, it takes a long time until air contained in oil is expelled through the oil bleed passage.

In order to avoid this problem, in the case of a chain tensioner having a screw rod, the screw rod preferably has in a rear end portion thereof an air passage for guiding air contained in oil in the oil passage into a portion of the cylinder chamber near a closed end thereof. With this arrangement, air contained in oil that has been fed through the oil supply passage into the oil passage flows through the air passage into the cylinder chamber and is expelled through the air bleed passage. Thus, it is possible to expel air in an extremely short period of time.

In a specific arrangement, there are a plurality of the air passages, the air passages comprising radial through holes extending between the outer periphery of the screw rod and the oil passage. In another specific arrangement, the air passage comprises a radial groove formed in the rear end surface of the screw rod.

In a still another arrangement, the cylindrical portion of the valve seat has in its upper portion such an air passage. With this arrangement, it is possible to reliably guide air in the cylindrical portion into the portion of the cylinder chamber near the closed end thereof, irrespective of the rotational position of the screw rod.

When such an air passage is formed in the screw rod or the cylindrical portion of the valve seat, the oil passage is preferably a tapered hole of which the diameter decreases toward its oil exit. With this arrangement, due to the throttling effect at the oil exit, and the tapered inner wall of the oil passage, air contained in the oil is less likely to flow toward the exit of the oil passage, so that air can be more smoothly guided into the air passage.

### BRIEF DESCRIPTION OF THE DRAWINGS

Other features and objects of the present invention will become apparent from the following description made with reference to the accompanying drawings, in which:

FIG. 1 is a front view of a tension adjusting device including a chain tensioner according to the present invention;

FIG. 2 is a vertical sectional front view of the chain tensioner shown in FIG. 1;

FIG. 3 is a partial enlarged sectional view of the chain tensioner of FIG. 2, showing an air bleed passage;

FIG. 4 is a partial enlarged sectional view of FIG. 3;

FIGS. 5-7 are views similar to FIG. 4 and showing modified air bleed passages;

FIG. 8 is a sectional view of a different chain tensioner embodying the present invention;

FIG. 9 is a sectional view taken along line IX-IX of FIG. 8;

FIG. 10 is a partial sectional view of a modified chain tensioner having a different screw rod;

FIG. 11A is a partial sectional view of a modified chain tensioner having an air passage formed in the cylindrical portion of the valve seat;

FIG. 11B is a partial sectional view of a modified chain tensioner having a different air passage formed in the cylindrical portion of the valve seat; and

FIG. 12 is a sectional view of a still different screw rod.

### DETAILED DESCRIPTION OF THE PREFERRED EMBODIMENTS

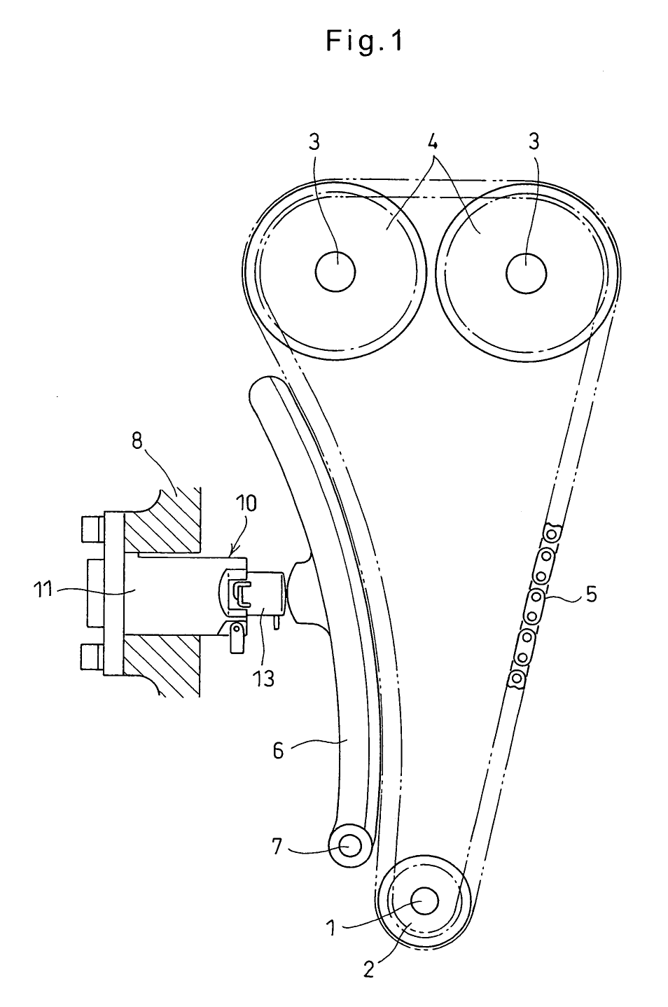

Now the embodiments of this invention are described with reference to the drawings. FIG. 1 shows a chain tension adjusting device. As shown, a chain 5 is trained about a sprocket 2 mounted to one end of a crankshaft 1, and sprockets 4 each mounted to one end of one of camshafts 3.

A chain guide 6 is provided to extend along a slack side of the chain 5. The chain guide 6 is pivotable about a shaft 7. An adjusting force is applied from a chain tensioner 10 to the chain 5 through the chain guide 6.

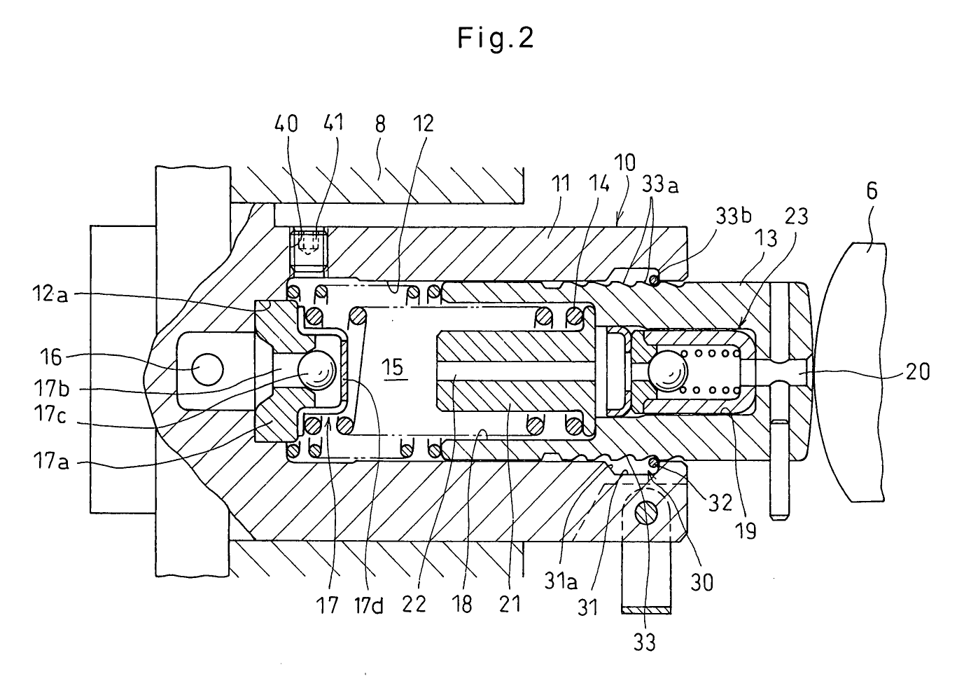

As shown in FIG. 2, the chain tensioner 10 includes a housing 11 configured to be mounted to an engine cover 8. The housing 11 defines a cylinder chamber 12 having a closed end. In the cylinder chamber 12, a plunger 13 and a return spring 14 are mounted. The return spring 14 biases the plunger 13 outwardly of the cylinder chamber.

The plunger 13 defines therebehind a pressure chamber 15 in the housing 11. The housing 11 is formed with an oil supply passage 16 communicating with the pressure chamber 15. At the oil exit of the oil supply passage 16, a check valve 17 is provided.

The check valve 17 comprises a valve seat 17a pressed into a small-diameter hole 12a formed in the closed end of the cylinder chamber 12 and formed with a valve hole 17b, a check ball 17c for selectively opening and closing the end of the valve hole 17b facing the pressure chamber 15, and a retainer 17d for restricting the movement of the check ball 17c, thereby restricting the degree of opening of the valve. When the pressure of the oil in the pressure chamber 15 exceeds the oil supply pressure in the oil supply passage 16, the check ball 17c closes the valve hole 17b, thereby stopping the supply of oil from the oil supply passage 16 into the pressure chamber 15.

The plunger 13 is formed with a spring receiving bore 18 extending axially from the rear end of the plunger 13, which is located in the cylinder chamber 12. In the front end surface of the bore 18, a valve receiving recess 19 is formed. An oil discharge passage 20 axially extends between the front end of the recess 19 and the front end surface of the plunger 13. The spring receiving bore 18 forms a portion of the pressure chamber 15, and receives the front end portion of the return spring 14. A packing member 21 is disposed between the front end of the return spring 14 and the end surface of the spring receiving bore 18 to reduce the volume of the pressure chamber 15. An axial oil passage 22 extends through the packing member 21.

Through the oil discharge passage 20, the pressure chamber 15 communicates with the exterior. The oil discharge passage 20 is selectively opened and closed by a relief valve 23 mounted in the valve receiving recess 19. The relief valve 23 is configured to close the oil discharge passage 20 while the pressure of oil in the pressure chamber 15 is lower than a threshold value, and open the passage 20 when the oil pressure in the pressure chamber 15 exceeds the threshold value.

A retraction restricting means 30 is provided between the housing 11 and the plunger 13 which prevents the plunger 13 from retracting toward the closed end of the cylinder chamber 12 by a distance greater than a predetermined value.

The retraction restricting means 30 comprises a ring receiving groove 31 formed in the inner surface of the cylinder chamber 12 near its open end, a radially elastically deformable register ring 32 received in the ring receiving groove 31, and a plurality of annular grooves 33 formed in the outer periphery of the plunger 13 so as to be axially spaced from each other at equal intervals. The register ring 32 is elastically pressed against one of the annular grooves 33. Each annular groove 33 comprises a tapered surface 33a of which the diameter gradually decreases toward the front end of the plunger 13, and an engaging surface 33b extending obliquely radially outwardly from the small-diameter end of the tapered surface 33a.

When the plunger 13 is pushed outwardly by the return spring 14, the register ring 32 is radially expanded by the tapered surface 33a of one of the annular grooves 33 and moved into the rear adjacent annular groove 33, thus allowing the plunger 13 to move outwardly. When a pushing force is applied to the plunger 13, the register ring 31 abuts a rear wall 31a of the ring receiving groove 31. The register ring 32 is thus trapped between the rear wall 31a and the engaging surface 33b of the annular groove 33, thus preventing any further retraction of the plunger 13.

The housing 11 is formed with a threaded hole 40 extending from the upper portion of its outer periphery to the pressure chamber 15. A screw 41 is in threadedly engagement with the threaded hole 40.

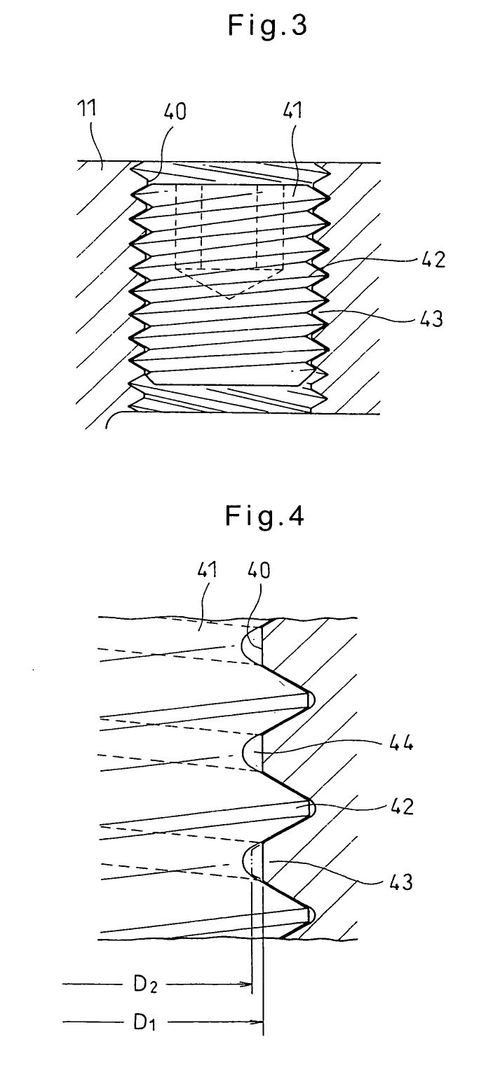

As shown in FIGS. 3 and 4, the external thread 42 formed on the screw 41 is one under JIS (Japanese Industrial Standards), while the internal thread 43 formed on the inner surface of the threaded hole 40 has an internal diameter D1 (i.e. the diameter of the threaded hole 43 before the internal thread 43 is formed) that is larger than the internal diameter (D2 in FIG. 4) of an internal thread under JIS. The gap defined between the threadedly engaged portions of the internal thread 43 and the external thread 42 serves an air bleed passage 44.

With the arrangement of this chain tension adjusting device, when the chain 5 vibrates and slackens due to changes in angular velocity of the crankshaft per rotation and fluctuations in torque of the camshafts, the plunger 13 moves outwardly (i.e. advances) under the force of the return spring 14, thereby re-tensioning the chain 5.

When the plunger 13 advances, the register ring 32 is radially expanded by the tapered surface 33a of one of the annular grooves 33, and when the plunger 13 advances by a distance greater than the pitch of the annular grooves 33, the ring 32 is moved into the rear adjacent groove 33. Thus, the ring 32 does not hinder the advancement of the plunger 13.

When the tension of the chain 5 increases, a pushing force is applied from the chain to the plunger 13 through the chain guide 6. This increases the pressure in the pressure chamber 15. When the pressure in the pressure chamber 15 exceeds the oil supply pressure in the oil supply passage 16, the check valve 17 closes the oil supply passage 16, so that the pushing force applied to the plunger 13 is damped by the oil trapped in the pressure chamber 15.

When the pressure in the pressure chamber 15 exceeds the threshold value of the relief valve 23, the relief valve 23 opens the oil discharge passage 20, thus discharging oil in the pressure chamber 15 through the oil discharge passage 20. This prevents over-tensioning of the chain 5.

In this state, if the plunger 13 is suddenly and quickly pushed out, and the pressure in the pressure chamber 15 falls sharply, air may be mixed into the pressure chamber 15. Air may be also mixed into the pressure chamber 15 from the oil supply passage 16 when the engine is started. Such air is discharged through the air bleed passage 44 when the plunger 13 retracts, and the pressure in the pressure chamber 15 begins to increase.

According to the present invention, because the internal thread 43 formed on the inner periphery of the threaded hole 40 has an internal diameter D1 that is larger than the internal diameter D2 of an internal thread under JIS, the air bleed gap 44 defined between the threadedly engaged portions of the internal thread 43 formed on the inner periphery of the threaded hole 40 and the external thread 42 formed on the outer periphery of the screw 41 is larger than a gap defined between similar internal and external threads of which the internal thread has an internal diameter that meets JIS.

Thus, when the plunger 13 retracts and the pressure in the pressure chamber 15 rises, any air trapped in the pressure chamber 15 can be smoothly discharged through the air bleed passage 44. The hydraulic damper can thus quickly return to its fully functional state.

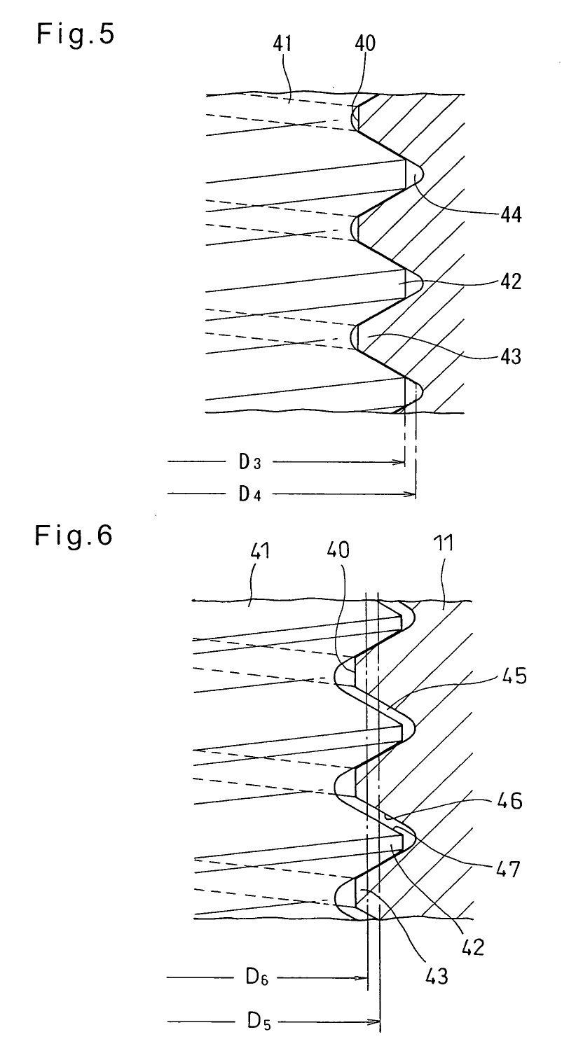

In the embodiment of FIG. 4, the internal thread 43 has an internal diameter D1 that is larger than the internal diameter D2 of an internal thread under JIS. But instead, as shown in FIG. 5, the external thread 42 formed on the outer periphery of the screw 41 may have an external diameter D3 smaller than the external diameter D4 of an external thread under JIS. In this case, too, it is possible to increase the air bleed passage, thereby smoothly expelling air in the pressure chamber.

FIG. 6 shows a different air bleed passage 44. In this embodiment, the internal thread 43 formed on the inner periphery of the threaded hole 40 has a pitch diameter D5 that is larger than the pitch diameter D6 of an internal thread under JIS. The gap defined between the threadedly engaged portions of the internal thread 43 and the external thread 42 serves an air bleed passage 45.

With this arrangement, because the pitch diameter D5 of the internal thread 43 formed on the inner periphery of the threaded hole 40 is larger than the pitch diameter D6 of an internal thread under JIS, a relatively large gap (air bleed passage) is formed between the top of the internal thread 43 and the bottom of the external thread 42, and further, a gap (air bleed passage) is also formed between the opposed flanks 46 and 47 of the internal and external threads 43 and 42.

Thus, this air bleed passage 45 has a larger cross-sectional area than the air bleed passage 44 shown in FIG. 3. Thus, it is possible to more smoothly expel air trapped in the pressure chamber 15 through this passage 44 when the plunger 13 retracts and the pressure in the pressure chamber 15 rises. The hydraulic damper can thus more quickly return to its fully functional state.

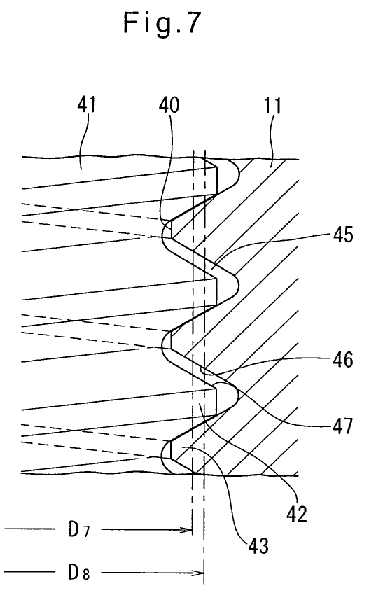

In the embodiment of FIG. 6, the internal thread 43 has a pitch diameter D5 that is larger than the pitch diameter D6 of an internal thread under JIS. But instead, as shown in FIG. 7, the external thread 42 formed on the outer periphery of the screw 41 may have a pitch diameter D7 smaller than the pitch diameter of an external thread D8 under JIS. In this case, too, it is possible to increase the air bleed passage, thereby smoothly expelling air in the pressure chamber. That is, a relatively large gap (air bleed passage) is formed between the bottom of the internal thread 43 and the top of the external thread 42, and further, a gap (air bleed passage) is also formed between the opposed flanks 46 and 47 of the internal and external threads 43 and 42.

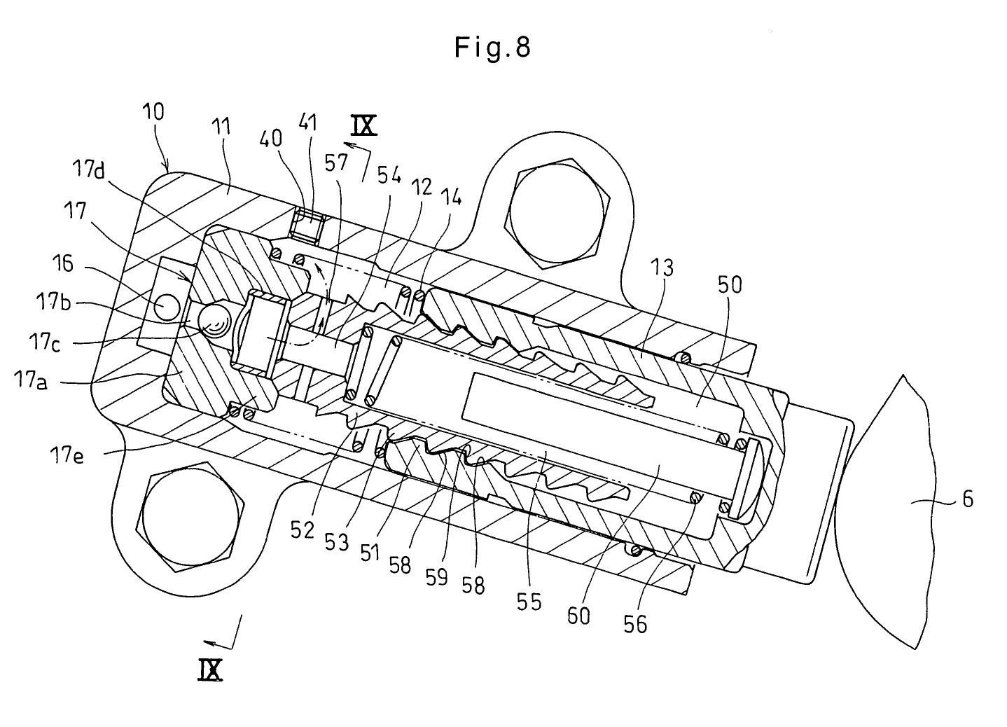

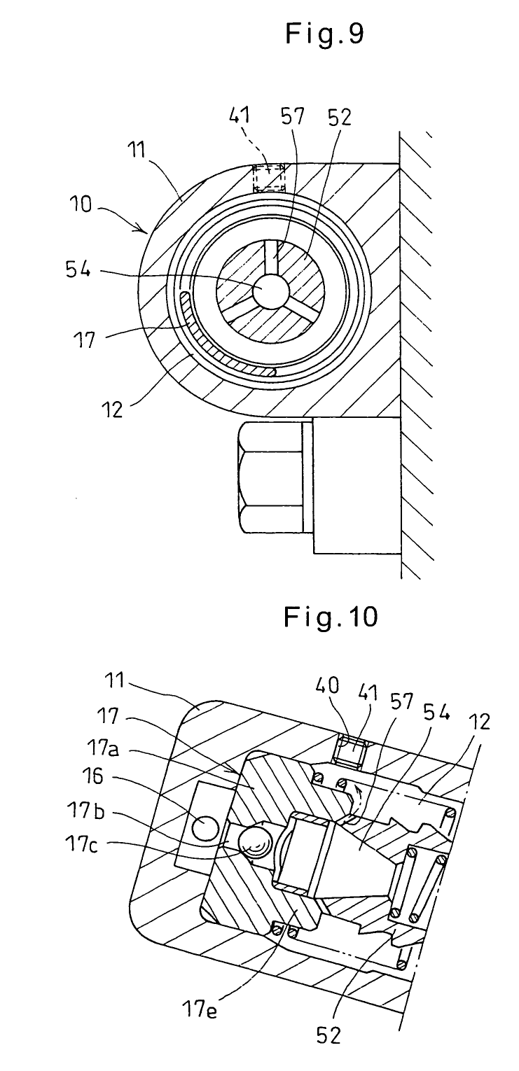

FIGS. 8 and 9 show a different chain tensioner 10 according to the present invention. The chain tensioner 10 according to this embodiment includes a plunger 13 formed with a rod inserting hole 50 having a rear opening facing the check valve 17. An internal thread 51 having a serration-shaped axial section is formed on the inner periphery of the rod inserting hole 50. A screw rod 52 having on its outer periphery an external thread 53 having a serration-shaped axial section is inserted in the rod inserting hole 50 with its external thread 53 in threaded engagement with the internal thread 51. The screw rod 52 is formed with an oil passage 54 extending along its axis and having a rear open end, and a spring receiving bore 55 also extending along the axis of the screw rod 52 and communicating with the oil passage 54. The bore 55 has a front open end. A rod spring 56 and a spring seat 60 are mounted between the rear closed end of the spring receiving bore 55 and the front closed end of the rod inserting hole 50. The spring 56 biases the screw rod 52 toward an end surface of a cylindrical portion 17e formed on the valve seat 17a of the check valve 17. The spring 52 also biases the plunger 13 outwardly.

A plurality of circumferentially equidistantly spaced radial holes or air passages 57 are formed in the rear end portion of the screw rod 52 through which the portion of the cylinder chamber 12 near its closed end communicates with the oil passage 54. Otherwise, the chain tensioner of this embodiment is identical to the chain tensioner shown in FIG. 2. Thus, identical elements are denoted by identical numerals, and their description is omitted.

The internal and external threads 51 and 53 have pressure flanks 58 which are pressed against each other when a pushing force is applied to the plunger, thereby receiving the pushing force. The pressure flanks 58 have a larger flank angle than the opposite clearance flanks 59 so that the threads 51 and 53 have a serration-shaped axial section. Also, the internal and external threads 51 and 53 have such a lead angle as to allow the plunger 13 to move outwardly while turning under the force of the rod spring 56.

The chain tensioner 10 is mounted in position to press the chain guide 6 shown in FIG. 1 with the plunger 13, which is biased outwardly by the return spring 14. The tensioner 10 is mounted with the housing 11 inclined such that the plunger 13 protrudes obliquely downwardly from the housing 11 with the air bleed passage 44 located at a higher level.

In this state, when the chain 5 vibrates and slackens due to changes in angular velocity of the crankshaft per rotation and fluctuations in torque of the camshafts, the plunger 13 moves outwardly under the force of the return spring 14, thereby re-tensioning the chain 5.

When the plunger 13 moves outwardly, the screw rod 52 begins to move in the same direction together with the plunger. But as soon as the screw rod 52 separates from the check valve 17, the screw rod 52 moves back while rotating under the force of the rod spring 56 until the screw rod 52 abuts the check valve 17 again.

When the plunger 13 moves outwardly, and the screw rod 52 moves back, the pressure in the housing 11 falls, so that the check valve 17 opens, allowing the oil in the oil supply passage 16 to flow into the housing 11.

When the tension of the chain 5 increases and the pushing force is applied to the plunger 13 from the chain, the pushing force is supported by the oil trapped in the cylinder chamber 12, rod inserting hole 50 and spring receiving bore 55, and by the pressure flanks 58 of the internal and external threads 51 and 53, so that the plunger 13 does not retract. But if this pushing force is larger than the combined force of the return spring 14 and the rod spring 56, the plunger 13 retracts while rotating.

In this state, with the oil supply passage 16 closed by the check valve 16, oil in the rod inserting hole 50 and the spring receiving bore 55 flows through the gap between the threadedly engaged portions of the internal and external threads 51 and 53 into the cylinder chamber 12, and oil in the cylinder chamber 12 leaks through a gap between the sliding surfaces of the cylinder chamber 12 and the plunger 13 to the exterior. Thus, the plunger 13 slowly retracts until the pushing force applied to the plunger balances with the combined force of the return spring 14 and the rod spring 56, thereby keeping constant the tension of the chain 5.

When the engine is stopped, a pushing force may be continuously applied to the plunger 13 through the chain guide 6 according to the positions of the cams where they stopped. But since this pushing force is supported by the pressure flanks 58 of the internal and external threads 51 and 53, the plunger 13 never retracts deep into the cylinder chamber 12.

Thus, when the engine is restarted, the chain 5 never significantly slackens, so that the plunger 13 never significantly protrudes outwardly. This prevents entry of outer air into the cylinder chamber 12, which can impair the damper effect.

Also, when the engine is stopped, oil in the housing 11 and the oil supply passage 16 returns to the oil pump, so that the amount of oil in the housing 11 decreases. Therefore, when the engine is restarted, air is inevitably introduced through the oil supply passage 16 into the oil passage 54.

But with the arrangement of the present invention, because the oil passage 54 communicates with the portion of the cylinder chamber 12 near its closed end through the plurality of circumferentially equidistantly spaced air passages 57 formed in the rear end portion of the screw rod 52, any air contained in the oil that flows through the oil passage 54 flows through the air passages 57 into the cylinder chamber 12, and is expelled through the air bleed passage 44.

Since any air contained in oil flows through the air passage 57 into the cylinder chamber 12 and is directly expelled through the air bleed passage 44, it is possible to effectively remove air. Thus, it is possible to fill the interior of the housing 11 with oil in a short period of time. The chain tensioner thus quickly begins to function as a hydraulic damper, thereby reliably preventing noise due to flapping of the chain 5.

As shown in FIGS. 8 and 9, since the plurality of air passages 57 are formed at equal intervals in the circumferential direction of the screw rod 52, even when the screw rod 52 rotates, one of the passages 57 is always at an upper level of the rod 52, so that any air contained in engine oil can be reliably guided through the air passages 57 into the cylinder chamber 12.

The oil passage 54 shown in FIG. 8 is a straight hole. But the oil passage 54 according to the invention is not limited thereto. For example, as shown in FIG. 10, the oil passage 54 may be a tapered hole of which the oil exit has a smaller diameter.

By using such a tapered oil passage 54, it is possible to prevent collision of oil against the rear end surface of the screw rod 52, thereby preventing turbulence of the oil flow, and thus production of bubbles in the oil. Also, due to the throttling effect at the oil exit, and the tapered inner wall of the oil passage 54, air contained in the oil is less likely to flow toward the exit of the oil passage 54, so that air can be more smoothly guided into the air passages 57.

In FIG. 8, the air passages 57 are through holes. But as shown in FIG. 8, the air passages 57 may be radial grooves formed in the rear end surface of the screw rod 52. With this arrangement, irrespective of the rotational position of the screw rod 52, it is possible to reliably expel air in the cylindrical portion 17e of the valve seat 17a into the portion of the cylinder chamber 12 near its closed end through the air passages 57.

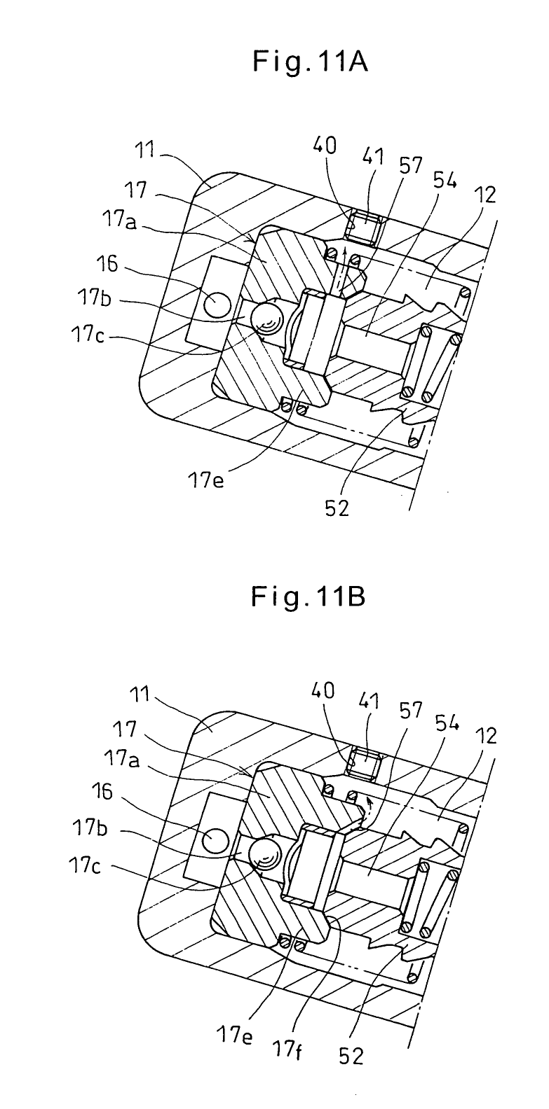

In the embodiments of FIGS. 8 and 10, the air passages 57 are formed in the screw rod 52 at its rear end portion. But instead, as shown in FIGS. 11A and 11B, at least one air passage 57 may be formed in the cylindrical portion 17e of the valve seat 17a.

The at least one air passage 57 in the embodiment of FIG. 11A is a through hole formed in the cylindrical portion 17e to extend from its outer surface to inner surface. The air passage 57 in the embodiment of FIG. 11B is a radial grooves formed in the upper portion of a tapered surface 17f of the cylindrical portion 17e that is in abutment with the screw rod 52.

By forming the at least one air passage 57 in the cylindrical portion 17e as shown in FIGS. 9A and 9B, irrespectively of the rotational position of the screw rod 52, it is possible to reliably guide air in the cylindrical portion 17e into the cylinder chamber 12 through the air passage 57. It is not necessary to form more than one such air passage 57. The single air passage can be formed more easily than the plurality of air passages 57 formed in the screw rod 52.

In today's automotive engines, motor oil containing organic molybdenum (known as friction modifier oil; hereinafter referred to as “FM oil”) is increasingly used. Due to tribochemical reaction with a ferrous sliding member, FM oil forms a film having an extremely low friction coefficient on the sliding member, thereby reducing the slide resistance between sliding members. This greatly improves the fuel economy of a motor vehicle.

If FM oil is used in the engine to which the chain tensioner of FIG. 8 is mounted, the FM oil that has been fed into the chain tensioner 10 may form a film having an extremely low friction coefficient between the surfaces of the internal thread 51 of the plunger 13 and the external thread 53 of the screw rod 52. If such a film is formed, the friction coefficient between the threadedly engaging portions decreases to an extremely low value. Thus, if the engine is stopped with the tension of the chain 5 kept high according to the positions of the cams when they stopped, the plunger 13 may be pushed deep into the cylinder chamber 12. If this happens, when the engine is restarted, the chain 5 tends to flap violently, producing noise.

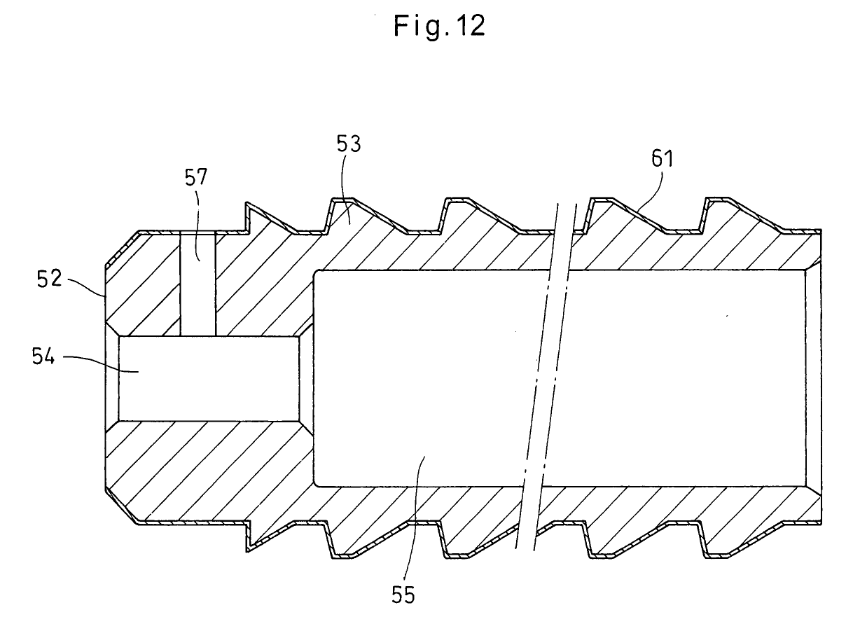

In order to avoid this problem, in the embodiment of FIG. 12, a film 61 is formed on the surface of external thread 53 of the screw rod 52 that is non-reactive with any additives contained in FM oil. The film 61 may be a carbon film, ceramic film or plating film.

By forming the film 61, which is non-reactive with additives contained in FM oil, on the surface of the external thread 53 of the screw rod 52, it is possible to suppress a reduction in frictional resistance between the thread surfaces due to tribochemical reaction. Thus, it is possible to prevent the plunger from being pushed deep into the cylinder chamber while the engine is at a stop, thereby preventing vibration of the chain 5 when the engine is restarted.

What is claimed is:

1. A chain tensioner comprising:
a housing defining a cylinder chamber;
a plunger mounted in said cylinder chamber so as to be slidable along an inner surface of said cylinder chamber, a return spring mounted in said cylinder chamber and biasing said plunger outwardly of said cylinder chamber;
said housing being formed with an oil supply passage communicating with a pressure chamber defined in said housing behind said plunger;
a check valve disposed at an oil exit of said oil supply passage and configured to close said oil supply passage when the pressure in said pressure chamber is higher than the pressure in said oil supply passage;
said housing being formed with a threaded hole extending from an upper portion of an outer periphery of said housing to said pressure chamber and having an internal thread formed on an inner periphery thereof; and
a screw having an external thread formed on an outer periphery thereof and kept in threaded engagement with said internal thread of said threaded hole, whereby a gap is defined between threadedly engaged portions of said internal and external threads, said gap serving as an air bleed passage;
wherein said internal thread of said threaded hole has an internal diameter larger than an internal diameter of an internal thread under JIS, or said external thread of said screw has an external diameter smaller than an external diameter of an external thread under JIS.

2. A chain tensioner comprising:
a housing defining a cylinder chamber;
a plunger mounted in said cylinder chamber so as to be slidable along an inner surface of said cylinder chamber;
a return spring mounted in said cylinder chamber and biasing said plunger outwardly of said cylinder chamber;
said housing being formed with an oil supply passage communicating with a pressure chamber defined in said housing behind said plunger;
a check valve disposed at an oil exit of said oil supply passage and configured to close said oil supply passage when the pressure in said pressure chamber is higher than the pressure in said oil supply passage;
said housing being formed with a threaded hole extending from an upper portion of an outer periphery of said housing to said pressure chamber and having an internal thread formed on an inner periphery thereof; and
a screw having an external thread formed on an outer periphery thereof and kept in threaded engagement with said internal thread of said threaded hole, whereby a gap is defined between threadedly engaged portions of said internal and external threads, said gap serving as an air bleed passage;
wherein said internal thread of said threaded hole has a pitch diameter larger than a pitch diameter of an internal thread under JIS, or said external thread of said screw has a pitch diameter smaller than a pitch diameter of an external thread under JIS.

3. The chain tensioner of claim 1 wherein said plunger is formed with a rod inserting hole having a rear opening facing said check valve and a front closed end, and includes an internal thread having a serration-shaped section and formed on an inner periphery of said rod inserting hole;
said chain tensioner further comprising:
a screw rod including an external thread having a serration-shaped section and formed on an outer periphery thereof, said screw rod being inserted in said rod inserting hole with said external thread thereof in threaded engagement with said internal thread of said plunger, said screw rod having a spring receiving bore extending along an axis of said screw rod and having a front open end and a rear end surface, and an oil passage extending along said axis of said screw rod from said rear end surface of said spring receiving bore to a rear end surface of said screw rod;
said check valve including a valve seat formed with a cylindrical portion having an end surface; and
a rod spring mounted between said front closed end of said rod inserting hole and said rear end surface of said spring receiving bore and biasing said screw rod toward said end surface of said cylindrical portion of said valve seat, and said plunger outwardly.

4. The chain tensioner of claim 2 wherein said plunger is formed with a rod inserting hole having a rear opening facing said check valve and a front closed end, and includes an internal thread having a serration-shaped section and formed on an inner periphery of said rod inserting hole;
said chain tensioner further comprising:
a screw rod including an external thread having a serration-shaped section and formed on an outer periphery thereof, said screw rod being inserted in said rod inserting hole with said external thread thereof in threaded engagement with said internal thread of said plunger, said screw rod having a spring receiving bore extending along an axis of said screw rod and having a front open end and a rear end surface, and an oil passage extending along said axis of said screw rod from said rear end surface of said spring receiving bore to a rear end surface of said screw rod;
said check valve including a valve seat formed with a cylindrical portion having an end surface; and
a rod spring mounted between said front closed end of said rod inserting hole and said rear end surface of said spring receiving bore and biasing said screw rod toward said end surface of said cylindrical portion of said valve seat, and said plunger outwardly.

5. The chain tensioner of claim 3 wherein said screw rod has in a rear end portion thereof an air passage for guiding air contained in oil in said oil passage into a portion of said cylinder chamber near a closed end thereof.

6. The chain tensioner of claim 4 wherein said screw rod has in a rear end portion thereof an air passage for guiding air contained in oil in said oil passage into a portion of said cylinder chamber near a closed end thereof.

7. The chain tensioner of claim 5 wherein there are a plurality of said air passages, said air passages comprising radial through holes extending between the outer periphery of said screw rod and said oil passage.

8. The chain tensioner of claim 6 wherein there are a plurality of said air passages, said air passages comprising radial through holes extending between the outer periphery of said screw rod and said oil passage.

9. The chain tensioner of claim 5 wherein said air passage comprises a radial groove formed in said rear end surface of said screw rod.

10. The chain tensioner of claim 6 wherein said air passage comprises a radial groove formed in said rear end surface of said screw rod.

11. The chain tensioner of claim 3 wherein said cylindrical portion of said valve seat has in its upper portion an air passage for guiding air contained in oil in said cylindrical portion into a portion of said cylinder chamber near a closed end thereof.

12. The chain tensioner of claim 4 wherein said cylindrical portion of said valve seat has in its upper portion an air passage for guiding air contained in oil in said cylindrical portion into a portion of said cylinder chamber near a closed end thereof.

13. The chain tensioner of claim 5 wherein said oil passage is a tapered hole of which the diameter decreases toward its oil exit.

14. The chain tensioner of claim 6 wherein said oil passage is a tapered hole of which the diameter decreases toward its oil exit.

15. The chain tensioner of claim 11 wherein said oil passage is a tapered hole of which the diameter decreases toward its oil exit.

16. The chain tensioner of claim 12 wherein said oil passage is a tapered hole of which the diameter decreases toward its oil exit.
